(19) United States
(12) Patent Application Publication
(10) Pub. No.: US 2005/0209717 A1
(43) Pub. Date: Sep. 22, 2005

(54) Competitor evaluation method and apparatus

(76) Inventors: Michael S. Flint, Decatur, GA (US); Rodney U. Grubbs, Brookville, IN (US); James Ernest Hutchings, Toronto (CA)

Correspondence Address: Bose McKinney & Evans LLP;Intellectual Property Group, 2700 First Indiana Plaza, 135 North Pennsylvania Street, Indianapolis, IN, 46204, US

(21) Appl. No.: 11/073,812

(22) Filed: Mar. 7, 2005

Related U.S. Application Data
(60) Provisional application No. 60/551,132, filed on Mar. 8, 2004.

(51) Int. Cl. A63F 13/00

(52) U.S. Cl. 700/91

(57) ABSTRACT

A method and apparatus implemented on a computing device to generate competition data. An index value for each competitor is generated which provides for a comparative evaluation of competitors.

### CROSS-REFERENCE TO RELATED APPLICATION

This application claims the benefit of U.S. Provisional Patent Application Ser. No. 60/551,132, titled “Multi-Sports League Promotional System and Method”, to Flint et al., the disclosure of which is expressly incorporated by reference.

### BACKGROUND AND SUMMARY

The present invention relates to a method and apparatus implemented on a computing device to generate competition data, an index for comparing the competitive skill levels of various competitors and an index value for each of the competitors. The index value generated for each competitor provides for a comparative evaluation of competitors within a sports league or among competitors competing in different sports leagues.

The method may be implemented on a computing device to generate comparative competition data for a number of competitors of a sport league. The method includes the steps of receiving a plurality of competition data from the plurality of competitors of the sports league, applying a competition performance model to the plurality of competition data to obtain a result for each of the plurality of competitors, determining a transformation for the result for each of the plurality of competitors, applying the determined transformation to each of the results for each of the plurality of competitors to obtain a transformed result for each of the plurality of competitors, and displaying the transformed result for each of the plurality of competitors.

A computer program product is also described which is embodied in an computer readable medium. The computer program product includes instructions that when executed cause a computing device to be operable as a device for comparing competition data of a competitor to one or more potential opponents of a sports league. The device operates to display competition data for the competitor, to display competition data for the one or more potential opponents, and to display an index value for the competitor and for the one or more potential opponents.

### BRIEF DESCRIPTION OF THE DRAWINGS

FIG. 1 is a simplified schematic block diagram of one embodiment of the apparatus of the present invention.

FIG. 2 is a flow diagram of a process in accordance with the present invention.

FIG. 3 is a graphical representation of normalized competition data for a plurality of competitors.

FIG. 4 is a graphical representation of the original and stretched normalized competition data for a plurality of competitors.

FIG. 5 is a graphical representation of the original and skewed normalized competition data for a plurality of competitors.

FIG. 6 is a graphical representation of the original normalized competition data, stretched normalized competition data, skewed normalized competition data, and stretched an skewed normalized competition data for a plurality of competitors.

FIG. 7 is a screen display of a competitor's information input to the present invention by a competitor.

FIG. 8 is a screen display of information input to the present invention of the results of competition between competitors.

FIG. 9 is a screen display of information of the standings of individual competitors within a sports league including an index value indicative of the relative competitive skill of each of a plurality of competitors.

### DETAILED DESCRIPTION OF THE DRAWINGS

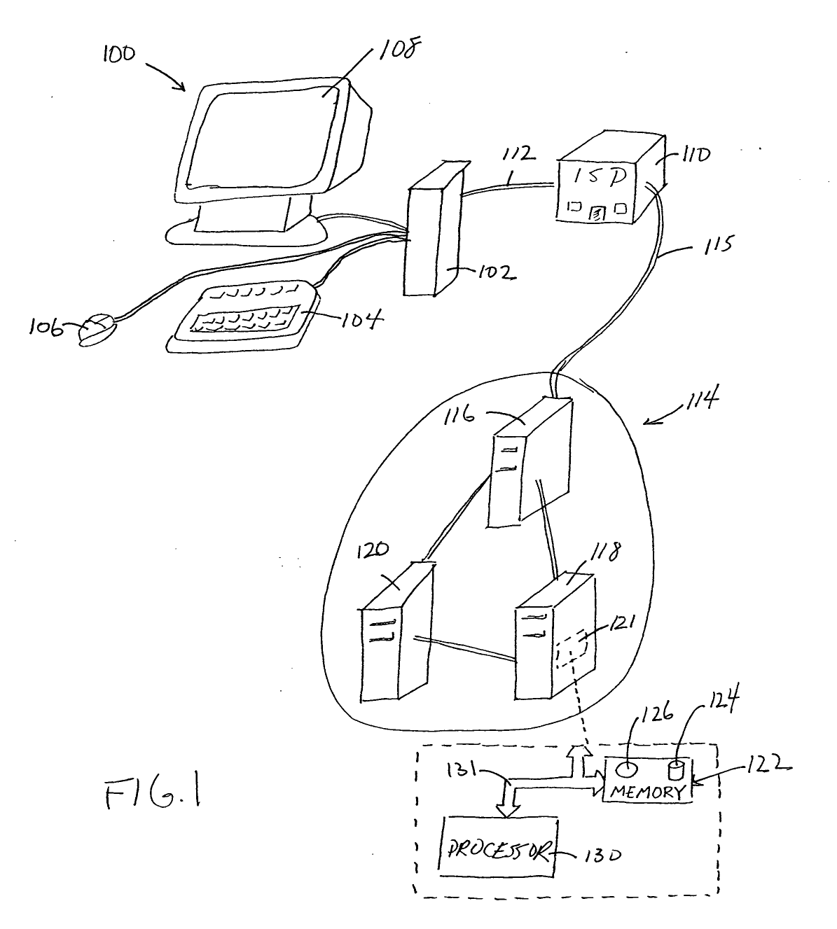

The present invention provides a method implemented on a computing device to generate competition data and a comparative competitor evaluation for the competitors of a sport league. In addition, a computer program product is described which is embodied in a computer readable medium which can be used for comparing competition data from a number of competitors or potential opponents of those competitors in a sport league. While the drawings show a particular application of the present invention directed to the collection and generation of comparative competition data for a number of competitors, it is understood that the present invention can be readily adapted to not only the sports described herein but to other sports as well. FIG. 1 illustrates one embodiment of an apparatus configured in accordance with the present invention. Those skilled in the art will appreciate from FIG. 1 that other embodiments not shown fall within the scope and spirit of the present invention.

FIG. 1 is a simplified schematic block diagram of one embodiment of an apparatus embodying the present invention. The apparatus of FIG. 1 includes a first computing device 100, such as a personal computer, having a system box 102 coupled to a keyboard 104 for inputting data or commands to the system box 102, a mouse 106 for inputting data or commands to the system box 102, and a display 108 for viewing data, application software graphics embodied in the system box 102, graphics, and other software driven materials as is understood by those skilled in the art. The system box 102 includes a processor, a memory, and a modem, not shown. The modem enables a user of the personal computer to communicate with other computers either through a networking system or through the Internet as is understood by those skilled in the art.

To communicate with other computers, computer users, and software packages stored on various other computers or servers throughout the Internet, the computing device 100 is coupled to an Internet service provider (ISP) 110 through a connection 112, typically a phone line or electrical power line. It is within the scope of the present invention to communicate by other means and methods such as wireless communication, Wi-Fi, and satellite communication. The Internet service provider typically provides access to the Internet to users or subscribers that pay a fee. The Internet service provider is coupled to the rest of the Internet 114, through a communication line 115. The Internet 114 may include, for instance, a number of routers 116, a number of servers 118, and a number of switches 120. Typically, the servers 118 include a computing device 121 which includes memory 122 to store data 124 and computing instructions 126. The memory 122 is coupled to one or more processors 130, through a bus 131, all of which resides within the server 118.

To access the Internet, a user logs onto the Internet through the personal computer and uses a web browser which is stored in the system box 102. The web browser displays a screen display on the monitor 108 such that the user can access data, information, graphics, and other material which resides on one or more servers on the Internet.

While the present invention includes a software package having particular applicability to a networked computing system, such as the Internet, the present invention is not limited to such a system. For instance, the present invention may also be embodied in other devices such as cellular phones and personal digital assistant devices. In addition, the computing device need not be connected to a network, but may include a stand alone device. For instance, the present invention may include a scientific calculator.

The present invention is directed to a method and apparatus to compare two or more competitors within a sports league and to measure the results of competitions between each of the competitors or players.

In many sports, the outcome of a competition between individual competitors or between teams is a winning team or individual, a losing team or individual and a score indicating the winner and the loser. Such a score, however, indicates the identity of the winner and the loser, but may not provide a comparison between the winner of that particular competition against the winner of another competition. As a result, comparisons between winners of different competitions provide only a general comparison. Consequently, a sport league may cluster a variety of competitors together according only to the higher level measures of ability, such as won-lost records. This grouping of individual competitors within a sports league often makes the resulting competition unbalanced.

Competitors may get compared with one another only through the most basic comparative data, for instance, the number of wins and the number of losses. Depending on the sport, the numbers which are used to generate the total number of wins and losses include the number of points and the number of games. In tennis, for example the number of matches that a player has won and lost during a league competition season is also available. While these numbers may be used to determine a stack ranking of competitive records within a sport league, such a stack ranking may not provide a meaningful way of comparing an individual competitor within one league against an individual competitor within another league. For instance, if one competitor in one league is 10 games up over the next most winning competitor in the league and a different competitor within another league is also 10 games up over his nearest competitor, there is no way to tell which competitor is the better competitor. One player may not be as strong and only barely won the 10 games or perhaps the opponents were defeated by a large margin.

The present invention provides a method and apparatus for not only comparing and evaluating competitors within a league, but also for comparing and evaluating competitors from one league to another league. Competition data is gathered from multiple competitors and may be used to create a measurement reflecting an individual competitor's performance within a league. The competition data includes multiple sources of information, for instance, the number of games won by an individual, the number of points won by an individual, and the number of matches won by an individual as well as taking into account this same information with respect to the individual competitor's opponents.

The present invention incorporates the multiple sources of competition data to create a measurement that reflects the performances of each of a league's competitors. This measurement is then normalized to a predetermined scale, such as a zero to 100 scale, thereby facilitating comparisons between individuals as well as between different leagues at different levels within a sport. Once the normalized measurement is provided on the selected scale, the distribution of values along the scale can be altered and adjusted in order to reflect the distribution and variation of skills amongst a group of players within a league.

While the normalized measurement of skills can be understood on the zero to 100 scale, it is possible that for the majority of competitors, a number indicating competitive ability, might fall within only a narrow range. For instance, out of 30 competitors there might be 28 competitors who have competitive ability values or index values of between 45 and 55. Some competitors may view the numbers as providing only a small amount of guidance since one player with an index value of 52 might see very little difference between himself and an upcoming opponent whose index value is 55, even though their respective playing histories might well demonstrate a significantly greater spread between them. In addition, the reverse is also possible depending on the sport and the method used to arrive at the overall values and provide numbers which are displaced from one another by a large amount, while the actual competitive difference is more narrow. The present invention uses a mathematical function to alter the original results of competition so that they either are spread out or compressed into values.

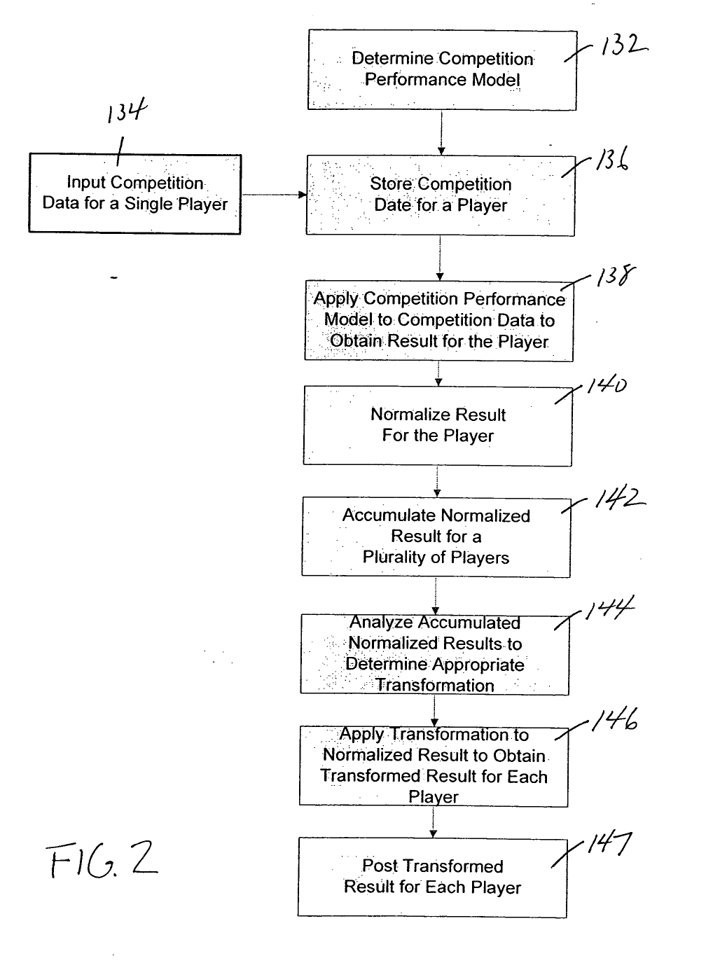

FIG. 2 illustrates a flow diagram in accordance with the present invention. At step 132 a competition performance model is determined. The competition performance model is determined as a means of taking into account the precise results of the games played and to express the games played as a ratio or series of ratios according to the selected model. For instance, one model might be comparing the actual result to the best possible result. Once the ratio or series of ratios is determined, then the series of ratios are weighted relative to one another, so that their respective impact on the respective competitions may provide a more accurate representation of the actual competitions. When determining these competition performance models, it is preferred to measure the results and to balance multiple measurements proportionately based on recommendations of the governing body of a selected sport. Once a competition performance model has been created for the sport of interest, the competition performance model can be applied to competition data for a single player which is input to the system at block 134. This competition data may be input by a single player into a web based browser application residing on the competitor's personal computer or can be collected by the league's administrator and input into a system residing at the league offices. Other forms of data collection and storage are within the scope of the present invention. Once the competition data has been input into the system, it is stored for each individual player at block 136 for use later with respect to the competition performance model.

The competition performance model uses equations and three numbers called differentials. The number of differentials may be determined based on the sport, its governing body, and the amount and type of data. A differential uses as its basis the difference between a player's result and that of his opponent—how many more (or less) matches/games/points the player won—then compares that difference with the maximum that could have been achieved, and expresses this as a ratio. As an example, the following differentials may be used for the sport of tennis.
MatchDifferential—(how many more matches this player won than his opponent did) divided by (maximum possible if the player won every match)
GameDifferential—(how many more games this player won than his opponent did) divided by (maximum possible if the player won every game)
PointDifferential—(how many more points this player won than his opponent did) divided by (maximum possible if the player won every game by a shutout)
   Whole numbers are then selected to weight the differentials. These numbers are called MatchWeight, GameWeight, and PointWeight. These are whole numbers whose relative proportions express the respective importance of each of the 3 differentials. Using these differentials, the competition performance model for tennis is:
   PrimaryRatio=100*(MatchDifferential*MatchWeight)+(GameDifferential*GameWeight)+(PointDifferential*PointWeight)/(MatchWeight*GameWeight*PointWeight)

Other ratios and other competition performance models are within the scope of the present invention for tennis as well as for other sports.

Once the competition performance model has been determined, the competition performance model is applied to the competition data which is stored for a player to obtain a first result for a single player at block 138. At block 140, the result for the individual player is normalized so that the value generated is between a pre-selected range of values, for instance zero to 100. It is also within the scope of the present invention to include the normalizing function within the competition performance model as illustrated in the equation above. Once the normalized result is obtained for each of the individual players, the normalized results for a plurality of players is accumulated at step 142. After the accumulated normalized results are obtained, these results are analyzed at step 144 to determine whether or not to apply a transformation. By analyzing the accumulated normalized results an appropriate transformation can be obtained. For instance, as previously described, if the normalized results fall within a narrow range of values, for instance, 45 to 55, it may be determined that these values should be stretched so that they are spread over a larger range of numerical values such as 25 to 75 instead of the current 35 to 65. Once the normalized results are obtained, a transformed result, also known as the index value, is posted at step 147.

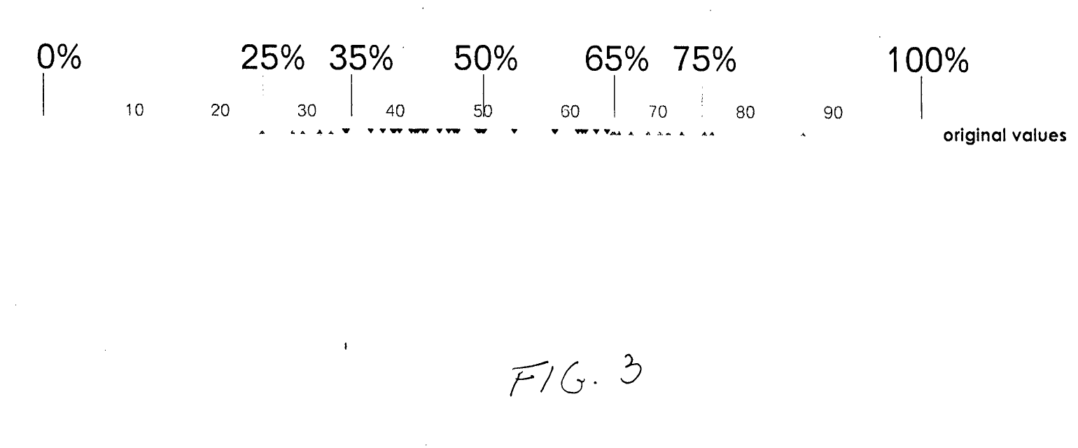

FIG. 3 illustrates the accumulated normalized results which are obtained at step 142. The downwardly pointing triangles which are illustrated as filled triangles, (as opposed to the upwardly pointing triangles), indicate that the values are clustered primarily between the 35% to 65% range. Many of these values are clustered in groups within the 40% to 50% range. Should an individual competitor view his index value, he may find little distinction between his value of 45.4, and his opponents value of 45.7. While these results are acceptable, the present invention provides for a transformation of the normalized values within a narrow range.

Once the appropriate transformation has been determined the transformation is applied to the normalized result to obtain a transformed result for each of the players.

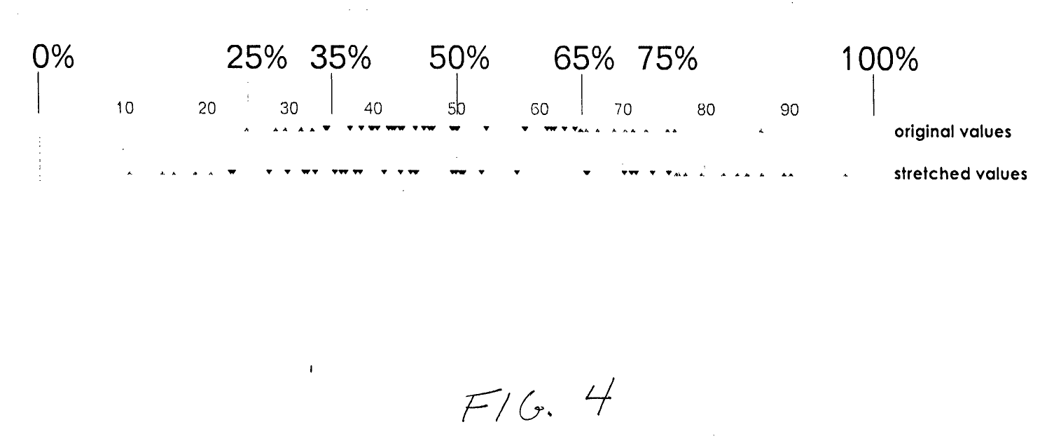

Referring now to FIG. 4, if it has been determined that the values need to be stretched, i.e. to be spread further apart, a stretch multiplier is applied to the normalized results to obtain a new distribution of values here illustrated as the stretched values of FIG. 4. The following equation is used.
newValue=oldvalue−StretchMultiplier*SINE(oldValue/100)*360/57.3;
where a
Stretchmultiplier is a number used to stretch (if>0) or compress (if<0) the distribution;
360=degrees in a circle;
57.3=conversion factor of degrees to radians;
100 as a divisor is required because we need to take the SINE of a value between 0 and 1.

Using a StretchMultiplier of 14 to modify the original distribution above would produce the values illustrated in FIG. 4 between approximately 25% and 75%. The central section of the chart where the original values were clustered has now been spread out to provide more distinctive index values for the most common values, while the highest and lowest values have been pushed closer to the end points making use of the entire length of the zero to 100 scale.

A Stretch Multiplier may be selected based on certain criteria set by the sports league to establish a standard or level of competition within a league or within a bracket. For instance, a benchmark may be selected to reflect a standard of achievement consistent with what the league considers to be the best and poorest performances amongst one's competitive peers. The league, for example, may wish to recognize all players having Index Values of greater than 80% through special recognition for excellence (perhaps earning that player a special award, or the right to advance to a tougher competition environment, league or bracket). For those competitors having Index Values of less than 20%, the league may decide to reevaluate the competitor's playing level and to move such a competitor to a different league or bracket. The exact value of a benchmark is typically set prior to the commencement of a league's first week of play, and may be reevaluated prior to subsequent seasons if player feedback suggests that a given benchmark seems unfairly high or low.

Second, the desired distribution of values within and without these benchmarks is determined. For instance, if the benchmark values of 80% and 20% have been chosen as the high and low cut-off values, respectively, then the league may decide that, on the average, 90% of all players' Index Values should fall between 80% to 20% range, and thus only 10% of the index values fall outside that range.

A Stretch Multiplier may then be selected which satisfies the two previous choices. That is, the amount by which the distribution will be transformed above and below its median will be chosen to fulfill the requirements. For the current example, the top 5% of values will exceed the 80% mark, and the bottom 5% of values will be less than the 20% mark. By knowing the range of actual transformed values received, the upper and lower values of the selected range, and the percentage of competitors selected to fall within that range, the Stretch Multiplier may be determined.

Using the present example (desiring 90% of values to fall between 20 and 80), the calculation of the StretchMultiplier is made by using the aforementioned equation, repeated below:
newValue=oldValue−StretchMultiplier*SINE(oldValue/100)*360/57.3
Since 90% of the sample distribution, by definition, falls between 5 and 95, and the desired distribution has been selected to fall instead between 20 and 80, the original value of 95% shall become 80% (or alternatively, an old value of 5 become 20, which yields the same StretchMultiplier). Thus the equation now becomes:
80=95—StretchMultiplier*SINE(95/100)*360/57.3
which, when solved, yields a StretchMultiplier of −48.5 (the negative number indicating a compression rather than a stretch). [NOTE: This equation assumes that SINE will be calculated using radians; if using degrees, change the 57.3 to 1.]

A second type of transformation which can be applied to the accumulated normalized results is a skew where a new medium value is chosen and the original or normalized indexed values are mapped accordingly. For instance, in the previous example where the values are generally evenly distributed on either side of 50, i.e., half the values are lower and half are higher, it may sometimes be necessary to skew the values either higher or lower if a particular sport's natural distribution of scores or results is centered elsewhere. As an example, should the distribution be centered around 20, then the values would be transformed to meet the index standard previously determined. A skew is performed by applying the following formula.

A skew is performed by applying the following formulae:
1) if the oldValue is less than 50:
   newValue=oldvalue*(TargetMedian−50);
2) if the oldValue is greater than 50:
   newValue=TargetMedian−(100−TargetMedian)+oldvalue*(100−TargetMedian)/50;
3) if the oldValue equals 50
   newValue=oldvalue;
   where a
TargetMedian is the ‘new’ median value that will create the desired final distribution;

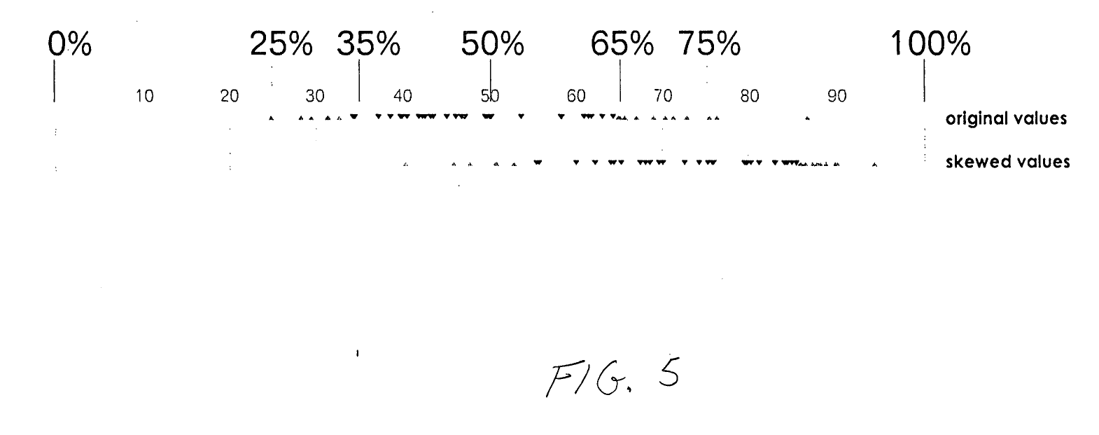

Using a TargetMedian of 80 to modify the original distribution produces the values illustrated in FIG. 5.

The results of the transformation of the normalized values by applying an algorithm to skew the values is illustrated in FIG. 5. As previously described, the downwardly pointing triangles represent the transformed index values which have been moved from the 35% to 65% range up to a skewed value of approximately 55% to 85%.

It is also within the scope of the present invention to combine these transformations by stretching the values and skewing the values at the same time. These transformations may also be combined to take everything into account, remapping the raw comparison values to the desired standard as follows:
1) if the oldValue is less than 50:
   newValue=(oldvalue−StretchMultiplier*SINE(oldValue/100)*360/57.3)*(TargetMedian−50)
2) if the oldValue is greater than 50:
   newValue=TargetMedian−(100−TargetMedian)+(oldvalue−StretchMultiplier*SINE(oldValue/100)*360/57.3;)*(100−TargetMedian
3) if the oldValue equals 50
   newValue=oldvalue−StretchMultiplier*SINE(oldValue/
   100)*360/57.3;

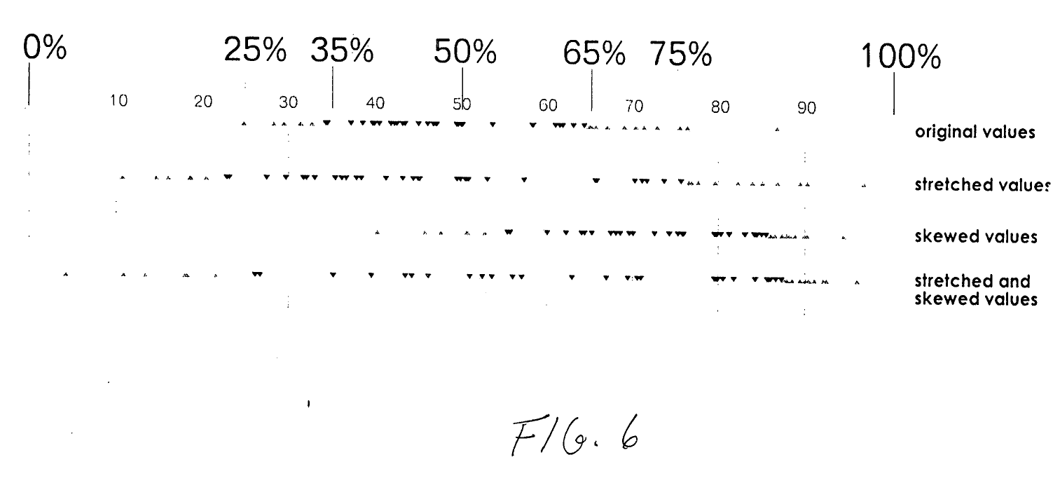

Combining the previous examples (StretchMultiplier of 14, TargetMedian of 80) produces the fourth line of values illustrated in FIG. 6.

As illustrated in FIG. 6, the stretched and skewed values are shown along with the stretched values, and the skewed values. Since the present invention may produce a balanced zero to 100 index for any sport, the index value may provide individual competitors not having any specialized knowledge to make meaningful comparisons of their competitive skills with other competitors. In addition, the present invention enables the comparison of players playing at one skill level or skill bracket to players playing at a different skill level or bracket or even with other competitors playing a completely different sport. For instance, it is possible that a competitor who knows his index value in the sport of tennis may make a comparison to another competitor who does not play tennis but who has an index value for the sport of racket ball.

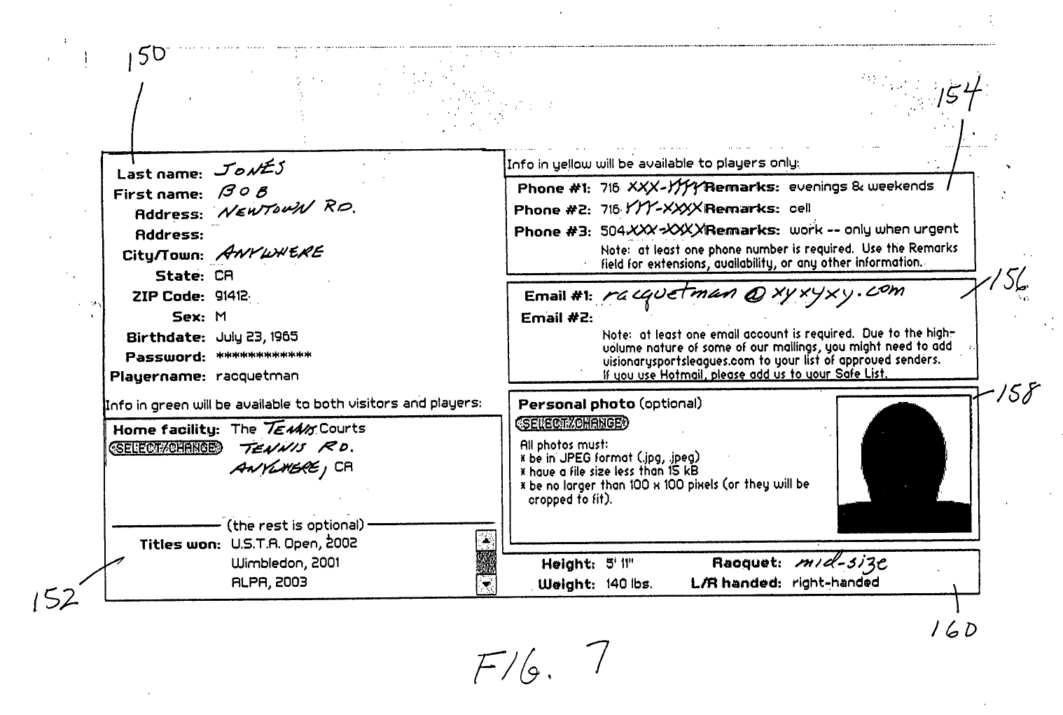

FIGS. 7, 8, and 9 illustrate one possible embodiment of the present invention using web browser software as described with respect to FIG. 1. As illustrated in FIG. 7, one portion of the computing device of the present invention is incorporated into the server 118. The computing instructions 126, when accessed through the web browser software of the personal computer, generate the screen display of FIG. 7 on the display. The screen display of FIG. 7 provides an individual competitor the opportunity to input personal information into the data base for use by the league and its competitors. The screen of FIG. 7 includes one or more input areas which capture individual data. An input area 150 is used by the user to input the user's name, address, city, state, zip code, and personal information such as birthday. Input area 152 is used to designate the individual competitor's home facility as well as any titles or awards won by the competitor during his previous competitions. Input area 154 provides contact information for the competitor which can include phone numbers for home, work or cell phone. Input area 156 provides additional contact information such as an email address. Input area 158 can be used to provide a personal photograph of the competitor. Lastly, input area 160 provides personal data such as height, weight, handedness, as well as the type of racket used for in this case the sport of tennis. The data within each of these input areas is either input through keystrokes on the keyboard 104 or through the use of pull down menus as would be understood by one skilled in the art.

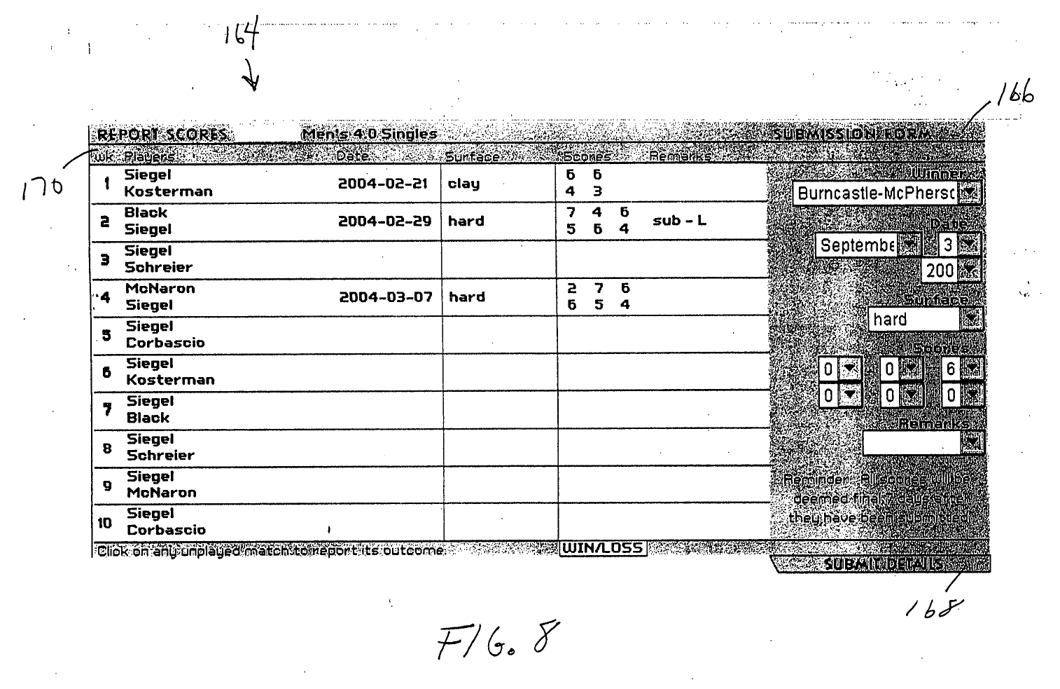

FIG. 8 is a screen display 164 of the present invention where competition data is input by an individual competitor. The screen display includes a user accessible submission area or form 166 which includes a variety of pull down menus for indicating the winner, the date of the competition, the type of surface in the tennis example, and the scores for the matches played, as well as remarks. Once the information has been input into the submission area 166 by the user, the user would select the submit details button 168 which inputs the data to the memory 122 of the computing device. This information is then organized such that it can be displayed in a report area 170 where the individual competitor along with his or her opponent(s) may be displayed. As can be seen, the competitors of this league play a single match a week, the dates of which are displayed as well as the scores.

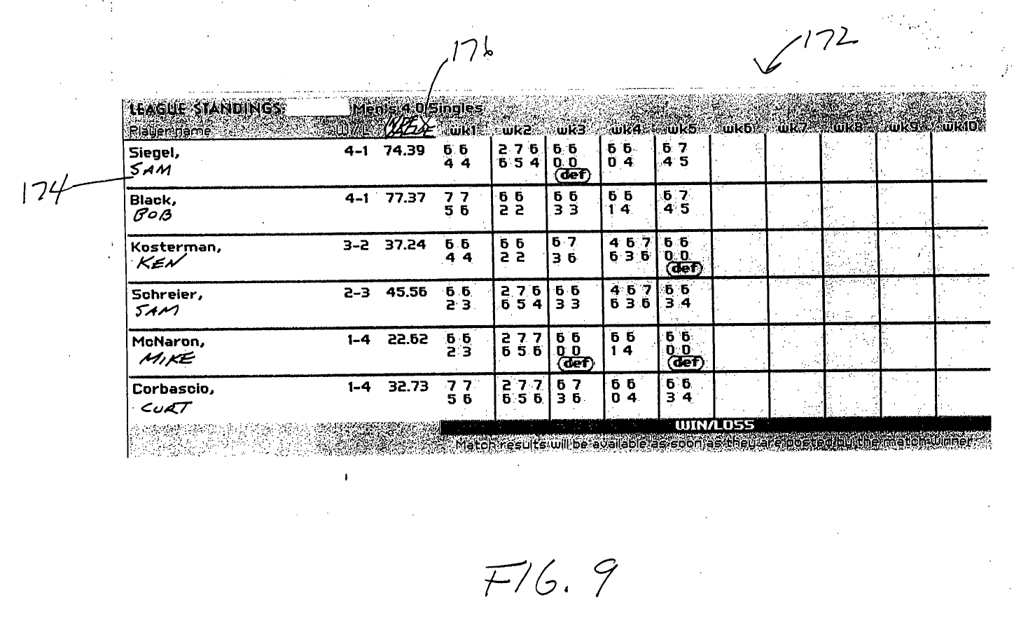

FIG. 9 is a screen display of information related to the standings of individual competitors within the described sports league including an index value indicating the relative competitive skill of each of the plurality of competitors. As can be seen in FIG. 9, each player's name is displayed within the league standing screen 172. Each player is provided a horizontal row of information 174 where the various data input by the individual competitor is shown. For instance, the won loss standings as well as the score of the matches for each week are displayed. It is this information which is used to determine the index value 176, which is displayed as well. As previously described, the index values have been generated based on the competitive data submitted by each of the individual competitors. The index values are used in this example to indicate the relative competitive level of each of the individuals displayed. For instance, the index values displayed in the screen 172 range from a value of 77.37 to a value of 22.62.

The index values have been generated using the described mathematical functions to alter the original values so that the values are either spread out or compressed depending on the typical range of values resulting from a selected sports evaluation method. While the present transformation has been described using sine transformations, it is also within the scope of the present invention to use the trigonometric equivalents as well as parabolic, hyperbolic, and exponential functions. Selection of any of these transformations is within the scope of the present invention. The present invention has been described using the sine function.

Although the invention has been described in detail with reference to certain exemplary embodiments, it is understood that variations and modifications exist within the scope and spirit of the present invention as defined and described in the appended claims. For instance, it is within the scope of the present invention to collect competition data other than through the Internet. A network is not required and data collection can be performed manually. Competition data may be submitted in person, phoned in, or sent by mail to a league office. The competition data, including the determined index values, may be posted on a bulletin board at the sports facility.

1. A method implemented on a computing device to generate comparative competition data for a plurality of competitors of a sport league, the method comprising the steps of:
receiving a plurality of competition data from the plurality of competitors of the sports league;
applying a competition performance model to the plurality of competition data to obtain a result for each of the plurality of competitors;
determining a transformation for the result for each of the plurality of competitors; and
applying the determined transformation to each of the results for each of the plurality of competitors to obtain a transformed result for each of the plurality of competitors.

2. The method of claim 1, further comprising displaying the transformed result for each of the plurality of competitors.

3. The method of claim 2, wherein the first applying step further comprises normalizing the first result for each of the plurality of competitors.

4. The method of claim 3, wherein the determining step further comprises determining the transformation for the normalized first result for each of the plurality of competitors.

5. The method of claim 4, wherein said displaying step further comprises displaying the transformed result for each of the plurality of competitors to a computing device including a display.

6. The method of claim 5, wherein the computing device comprises a personal computing device.

7. The method of claim 6, wherein the personal computing device comprises a personal computer.

8. The method of claim 2, further comprising determining a competition performance model.

9. The method of claim 8, wherein the competition performance model includes a match differential result.

10. The method claim 9, wherein the competition performance model includes subtracting the number of matches won by an opponent of one of the plurality of competitors from the number of matches won by the one competitor and dividing the result of subtracting by the maximum number of matches the one competitor would have won if the one competitor won every match.

11. The method of claim 8, wherein the competition performance model includes a game differential result.

12. The method of claim 11, wherein the game differential result includes subtracting the number of games won by an opponent of one of the plurality of competitors from the number of games won by the one competitor and dividing the result of subtracting by the maximum number of games the one competitor could have won if the one competitor won every game.

13. The method of claim 8, wherein the competition performance model includes a point differential result.

14. The method of claim 13, wherein the point differential result includes subtracting the number of points won by an opponent of one of the plurality of competitors from the number of points won by the one competitor and dividing the result of subtracting by the maximum number of points the one competitor could have won if the one competitor won every point possible in every game played.

15. The method of claim 2, wherein the determining steps comprises determining a transformation for the first result for each of the plurality of competitors, wherein the transformation includes a multiplier selected to adjust a distribution of the result for each of the plurality of competitors.

16. The method of claim 15, wherein the multiplier is selected to stretch the distribution.

17. The method of claim 15, wherein the multiplier is selected to compress the distribution.

18. The method of claim 15, wherein the multiplier is selected to skew the distribution.

19. The method of claim 1, wherein the transformed result comprises an index value, to indicate a relative competitive skill of each of the plurality of competitors.

20. The method of claim 1, wherein the transformed result for each of the plurality of competitors is a value of 0 to 100.

21. A computer program product embodied in an computer readable medium, the computer program product comprising instructions that when executed cause a computing device to be operable as a device for comparing competition data of a competitor to one or more potential opponents of a sports league, the device operating to:
display competition data for the competitor;
display competition data for the one or more potential opponents; and
display an index value for the competitor and for the one or more potential opponents.

22. The computer program product of claim 21, wherein the computer program product receives competition data for the competitor.

23. The computer program product of claim 22, wherein the computer program product receives competition data for the one or more potential opponents.

24. The computer program product of claim 23, wherein the computer program product is configurable to receive competition data from one or more different types of sports.
